(19) United States
(12) Patent Application Publication
(10) Pub. No.: US 2009/0164877 A1
(43) Pub. Date: Jun. 25, 2009

(54) MEMO VOICE RECORDING/PLAYBACK METHOD AND DIGITAL PHOTO FRAME USING THE SAME

(75) Inventors: Si-En Chang, Taipei (TW); Kun-Shien Tsai, Hsinchu City (TW); Ching-Hung Wu, Hsinchu County (TW); Ming-Deng Hsieh, Kaohsiung City (TW); Ming-Tsai Hsu, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: PROLIFIC TECHNOLOGY INC., Taipei (TW)

(21) Appl. No.: 12/272,725

(22) Filed: Nov. 17, 2008

(30) Foreign Application Priority Data
Dec. 25, 2007 (TW) 96149931

(51) Int. Cl. G06F 17/00; G10L 21/00

(52) U.S. Cl. 715/203; 704/275

(57) ABSTRACT

A memo voice recording/playback method and a digital photo frame using the method are provided. The method is suitable for a digital image playback apparatus. The digital image playback apparatus has memo voice recording function and memo voice playback function and includes a display unit for image displaying. The method includes: displaying an image; judging whether memo voice recording function of the digital image playback apparatus is enabled or not; and executing a memo voice recording procedure to edit the recorded memo voice into a memo voice file associated with the image if it is judged that the memo voice recording function is enabled.

### CROSS-REFERENCE TO RELATED APPLICATION

This application claims the priority benefit of Taiwan application serial no. 96149931, filed on Dec. 25, 2007. The entirety of the above-mentioned patent application is hereby incorporated by reference herein and made a part of this specification.

### BACKGROUND OF THE INVENTION

1. Field of the Invention

The present invention relates to a recording/playback method and a photo frame using the method, and more particularly, to a memo voice recording/playback method and a digital photo frame using the method.

2. Description of Related Art

Placing a photo within a photo frame is usually the way people keep wonderful memories. Upon seeing the photo in the photo frame, the user may recall the scenarios and happy time at the moment of taking the photo. However, merely seeing the photo can be humdrum. Accordingly, many types of photo frames have memo voice playback function providing the user with more fin in recalling the memories by playback of a memo voice. However, there are still drawbacks in these conventional constructions.

For example, U.S. Pat. No. 5,359,374 proposed to incorporate a memo voice recording/playback device into the traditional photo frame, allowing the user to listen to the memo voice while appreciating the photo. However, the construction proposed by this patent still employs the traditional photo and tape, and the memo voice recording/playback function necessitates manipulation of a button disposed on the photo frame. Because of the independent relationship between the photo frame and the memo voice recording/playback device, replacing the photo and tape both require manual operation.

As another example, U.S. Pat. No. 5,045,327 proposed a digital memo voice recording center that mainly includes a digital memo voice recording device with a removable digital memo voice playback module. The memo voice can be recorded through the digital memo voice recording device, and the recorded memo voice data can be transferred to the removable memo voice playback module. As such, the user can install the removable memo voice playback module into a compatible congratulation card or a traditional photo frame to replay the memo voice data on the congratulation card or photo frame. In this construction, however, the additional digital memo voice recording device is required to record the memo voice, and the recorded memo voice data is required to be transferred to the removable memo voice playback module, resulting in the inconvenience in storing the memo voice data. In addition, the memo voice playback module can only be used with those congratulation cards or photo frames that are compatible with the removable memo voice playback module. Moreover, this construction still employs the traditional photos.

In still another example, U.S. Pat. No. 5,365,686 proposed a memo voice recording/playback device combination and a U-shaped photo frame that can be inserted into the memo voice recording/playback device combination. The U-shaped photo frame includes a non-volatile IC memory chip therein. Upon inserting the U-shaped photo frame into the memo voice recording/playback device combination, the memo voice recording/playback device combination can replay memo voice data in the non-volatile IC memory chip. However, the U-shaped photo frame still employs the traditional photos, which can only display a single photo at a time. In addition, the user must manually replace the photos and replacing the photos can be difficult.

### SUMMARY OF THE INVENTION

The present invention is directed to a memo voice recording/playback method suitable for a digital image playback apparatus. The digital image playback apparatus has memo voice recording function and memo voice playback function, and includes a display unit for displaying image. Through this method, the user can employ the digital image playback apparatus to record or replay related memo voice associated with any image, or record or replay a memo voice associated with a message mode screen.

The present invention is also directed to a digital photo frame that can record or replay related memo voice associated with any image, or record or replay a memo voice associated with a message mode screen.

Accordingly, in one aspect, the present invention provides a memo voice recording/playback method for a digital image playback apparatus. The digital image playback apparatus has memo voice recording function and memo voice playback function and comprises a display unit for image displaying. The method comprises: displaying an image; judging whether or not memo voice recording function of the digital image playback apparatus is enabled; and executing a memo voice recording procedure to edit the recorded memo voice into a memo voice file associated with the image if it is judged that the memo voice recording function is enabled.

In another aspect, the present invention provides a digital photo frame having memo voice recording function and memo voice playback function. The digital photo frame mainly comprises a display panel for image displaying, a memo voice recording module, a memo voice playback module, and a control module. The control module is configured to control the display panel, the memo voice recording module, and the memo voice playback module. When the display panel displays an image and the memo voice recording function of the digital photo frame is enabled, the control module controls the memo voice recording module to execute a memo voice recording procedure so as to edit the recorded memo voice into a memo voice file associated with the image.

According to one embodiment of the memo voice recording/playback method or digital photo frame, the image is one of a digital photo, a digital still picture, a digital moving image, a message mode screen, and an image sequence.

According to the present invention, upon displaying an image, whether or not the memo voice recording function is enabled will be judged. If it is judged that the memo voice recording function is enabled, the memo voice recording procedure will be executed to edit the recorded memo voice into a memo voice file associated with the image. The image may be a digital still image, a digital photo, a digital moving image, a message mode screen, or an image sequence. Therefore, the present invention can record or replay related memo voice associated with any image, or record or replay a memo voice associated with the message mode screen.

In order to make the aforementioned and other features and advantages of the present invention more comprehensible, embodiments accompanied with figures are described in detail below.

### BRIEF DESCRIPTION OF THE DRAWINGS

FIG. 1 is a block diagram of a digital photo frame according to one embodiment of the present invention.

FIG. 2 is a flow chart of the memo voice recording/playback method according to one embodiment of the present invention.

FIG. 3 is a flow chart of a memo voice recording/playback method according to another embodiment of the present invention.

FIG. 4 is a flow chart of memo voice recording/playback method according to still another embodiment of the present invention.

FIG. 5 is a flow chart of operation to prevent the playback of a music file and a memo voice file at the same time.

### DESCRIPTION OF THE EMBODIMENTS

The present invention provides a memo voice recording/playback method suitable for a digital image playback apparatus. The digital image playback apparatus has memo voice recording function and memo voice playback function, and includes a display unit for image displaying. For the sake of clarity and ease of making comparison with conventional constructions, the digital image playback apparatus are illustrated in the following embodiments as digital photo frames, and the display unit of the digital image playback apparatus is illustrated as a display panel of the digital photo frame.

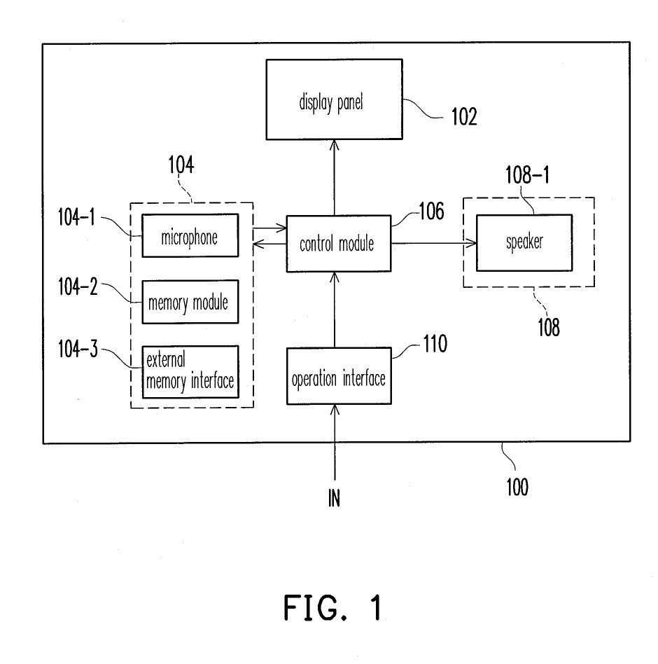

FIG. 1 is a block diagram of a digital photo frame according to one embodiment of the present invention. Referring to FIG. 1, the reference numeral 100 denotes a digital photo frame with memo voice recording function and memo voice playback function. The digital photo frame 100 mainly includes a display panel 102, a memo voice recording module 104, a control module 106, and a memo voice playback module 108. The display panel 102 operates to display an image, and the control module 106 operates to control the display panel 102, the memo voice recording module 104, and the memo voice playback module 108. In addition, the digital photo frame 100 further includes an operation interface 110 for transmitting an operation command IN from the user to the control module 106, such that the control module 106 controls the display panel 102, the memo voice recording module 104, and the memo voice playback module 108 in response to the operation command IN. The user may set the digital photo frame 100 in a digital image display mode, a message mode or another mode by inputting the operation command IN, and may also enable the memo voice recording function or memo voice playback function of the digital photo frame 100 by inputting the operation command IN.

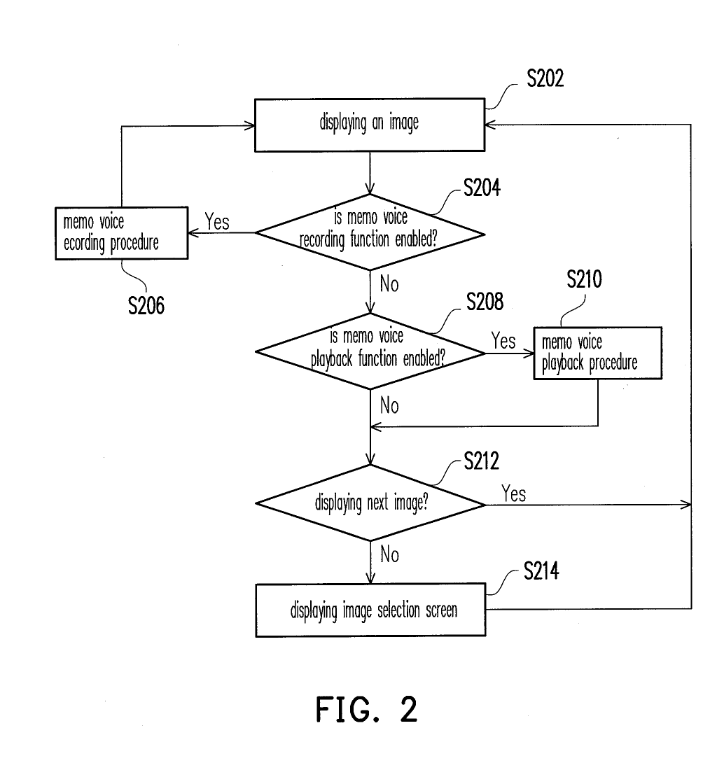

When the digital photo frame 100 operates in the digital image display mode, the user may control the digital photo frame 100 to display a next image by inputting an operation command IN. In this mode, operation of the digital photo frame 100 may be explained with reference to FIG. 2. FIG. 2 is a flow chart of the memo voice recording/playback method according to one embodiment of the present invention. Referring to FIGS. 1 and 2, if the display panel 102 displays an image (step S202 of FIG. 2), e.g., a digital still image, a digital photo, or a digital moving image, the control module 106 will judge whether or not the memo voice recording function of the digital photo frame 100 is enabled (step S204 of FIG. 2). If it is judged that the memo voice recording function is enabled, the control module 106 will control the memo voice recording module 104 to execute a memo voice recording procedure (step S206 of FIG. 2) so as to edit the recorded memo voice into a memo voice file associated with the image. After the memo voice recording procedure is completed, the control module 106 then controls the display panel 102 to continuously display the image. On the contrary, if it is judged that the memo voice recording module 104 is not enabled, the control module 106 will judge whether or not the memo voice playback function of the digital frame 100 is enabled (step S208 of FIG. 2).

If it is judged that the memo voice playback function is enabled, the control module 106 will control the memo voice playback module 108 to execute a memo voice playback procedure (step S210 of FIG. 2) so as to replay the memo voice file associated with the image. Thereafter, the control module 106 judges whether or not a next image is to be displayed (step S212 of FIG. 2). On the contrary, if it is judged that the memo voice playback function is not enabled, the control module 106 will directly perform the step S212. If it is judged that a next image is to be displayed, the control module 106 will control the display panel 102 to display the next image. On the contrary, if it is judged that no next image is to be displayed, the control module 106 will control the display panel 102 to display an image selection screen (step S214 of FIG. 2), allowing the user to select an image to be displayed.

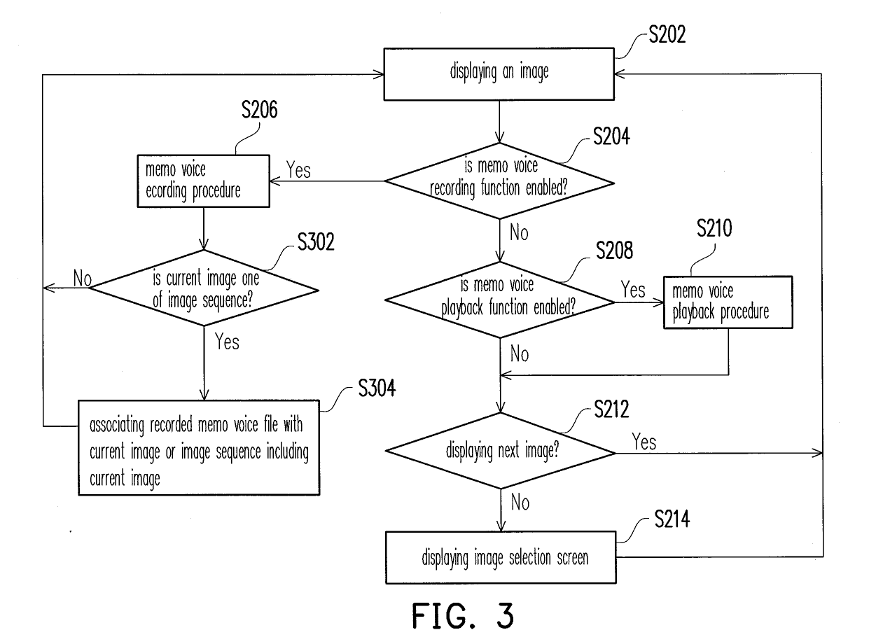

Suppose the displayed image in step S202 of FIG. 2 is an image sequence consisting of a plurality of digital photos or a plurality of digital still pictures, some additional steps can be performed as shown in FIG. 3. FIG. 3 is a flow chart of a memo voice recording/playback method according to an alternative embodiment of the present invention. Referring to FIGS. 2 and 3, the differences between the methods of FIG. 2 and FIG. 3 include: the method of FIG. 3 includes additional step S302 and step S304; and in FIG. 3, after step S206 is completed, the method proceeds to step 302 instead of returning to step S202. Referring to FIG. 3, after the step S206 is completed, it is further judged that whether or not the current image is one of the image sequence (step S302 of FIG. 3). If it is judged that the current image is not one of the image sequence, the method returns to the step S202. If it is judged that the current image is one of the image sequence, the recorded memo voice file is selected to be associated with the current image, i.e., the memo voice file is selected to be associated with a single image; or the recorded memo voice file is selected to be associated with an image sequence including the current image, i.e., the memo voice file is selected to be associated with an image sequence (step S304 of FIG. 3). Then, the method returns to step S202. In addition, as the step S214 of FIG. 3 is performed, i.e., as the image selection screen is displayed, a plurality of digital photos or a plurality of digital still pictures may be selected to constitute an image sequence. Of course, when step S212 of FIG. 3 is being performed, i.e., when whether or not to display an next image is being judged, the user can input a command to determine to display another image or alternatively display another one of the image sequence.

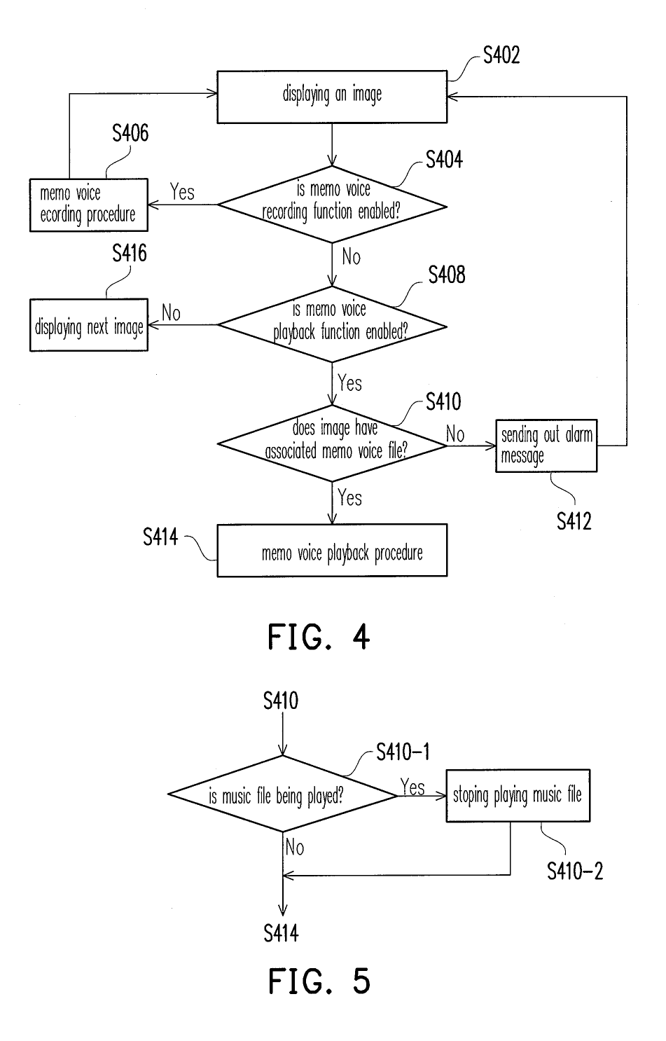

When the digital photo frame 100 operates in the message mode, operation of the digital photo frame 100 can be explained with reference to FIG. 4. FIG. 4 is a flow chart of memo voice recording/playback method according to still another embodiment of the present invention. Referring to FIGS. 1 and 4, when the display panel 102 displays an image (step S402 of FIG. 4), e.g., a message mode screen, the control module 106 will likewise judge whether the memo voice recording function of the digital photo frame 100 is enabled or not (step S404 of FIG. 4). If it is judged that the memo voice recording function is enabled, the control module 106 will control the memo voice recording module 104 to execute the memo voice recording procedure so as to edit the recorded memo voice into a memo voice file associated with the message mode screen. After the memo voice recording procedure is completed, the control module 106 likewise controls the display panel 102 to keep on displaying the message mode screen. On the contrary, if it is judged that the memo voice recording function is not enabled, the control module 106 will judge whether the memo voice playback function of the digital photo frame 100 is enabled or not (step S408 of FIG. 4).

If it is judged that the memo voice playback function is not enabled, the control module 106 will control the display panel 102 to display a next image (step S416 of FIG. 4). On the contrary, if it is judged that the memo voice playback function is enabled, the control module 106 further judges whether there is a memo voice file associated with the message mode screen (step S410 of FIG. 4), i.e., judging whether there is anyone leaving a message. If it is judged that there is no memo voice file associated with the message mode screen, the control module 106 will control the display panel 102 to display an alarm message (step S412 of FIG. 4), e.g., display a phrase/sentence such as, NO MESSAGE, or the like. After sending out the alarm message, the control module 106 controls the display panel 102 to keep on displaying the message mode screen. If it is judged that there is a memo voice file associated with the message mode screen, the control module 106 will control the memo voice playback module 108 to execute a memo voice playback procedure (step S414 of FIG. 4) so as to replay the memo voice file associated with the message mode screen.

As shown in FIG. 5, if the digital photo frame 100 also has music playback function, the flow chart as shown in FIG. 4 can provide additional judging function to prevent playback of a music file and a memo voice file at the same time. FIG. 5 is a flow chart of operation to prevent the playback of a music file and a memo voice file at the same time. Referring to FIGS. 1 and 5, after the step S410 of FIG. 4 is completed, the control module 106 further judges whether the memo voice playback module 108 is replaying a music file (step S410-1 of FIG. 5). If it is judged that the memo voice playback module 108 is replaying a music file, the control module 106 will control the memo voice playback module 108 to stop replaying the music file (step S410-2 of FIG. 5) and go to perform the step S414 of FIG. 4. On the contrary, if it is judged that the memo voice playback module 108 is not replaying any music file, the control module 16 will directly perform the step S414 of FIG. 4.

Referring to FIG. 1, the memo voice recording module 104 may be implemented in a wide variety of ways. In this exemplary embodiment, the memo voice recording module 104 mainly includes a microphone 104-1 and a memory module 104-2. The microphone 104-1 is controlled by the control module 106, and operates to receive a memo voice and transmit the received memo voice to the control module 106 for processing. The memory module 104-2 is also controlled by the control module 106, and operates to store the memo voice file. To provide a memory expansion capability, the memo voice recording module 104 may additionally include an external memory interface 104-3 that is also controlled by the control module 106. The external memory interface 104-3 can be used to interface with an external memory to realize expansion of the memory storage. Besides, the memo voice playback module 108 may also be implemented in a wide variety of ways. In this exemplary embodiment, the memory voice playback module 108 is implemented by a speaker 108-1 or alternatively by the speaker 108-1 cooperating with a memo voice amplifier (not shown). The operation interface 110 can operate in a wire or wireless manner.

Although in the embodiments described above, the present invention is illustrated as a digital photo frame, the memo voice recording/playback methods of the present invention are not limited to the application such as the digital photo frame or the like. Rather, the methods described in the above embodiments are suitable for any digital image playback apparatus, as long as the digital image playback apparatus has memo voice recording/playback function and includes a display unit for image displaying. In this regard, for example, an electronic board attached on an interior wall of a building can be considered a type of display unit. The digital image playback apparatus as described above can be achieved by adding the memo voice recording/playback function into the electronic board.

In summary, according to the present invention, upon displaying an image, it will be judged whether or not the memo voice recording function is enabled. If it is judged that the memo voice recording function is enabled, the memo voice recording procedure will be executed to edit the recorded memo voice into a memo voice file associated with the image. The image may be a digital still image, a digital photo, a digital moving image, a message mode screen, or an image sequence. Therefore, the present invention can record or replay related memo voice associated with any image, or record or replay a memo voice associated with the message mode screen.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memo voice recording/playback method for a digital image playback apparatus, the digital image playback apparatus having memo voice recording function and memo voice playback function and comprising a display unit for image displaying, the method comprising:
displaying an image;
judging whether or not memo voice recording function of the digital image playback apparatus is enabled; and
executing a memo voice recording procedure to edit the recorded memo voice into a memo voice file associated with the image if it is judged that the memo voice recording function is enabled.

2. The memo voice recording/playback method in accordance with claim 1, wherein if it is judged that the memo voice recording function is not enabled, the method further comprises:
judging whether or not memo voice playback function of the digital image playback apparatus is enabled; and
executing a memo voice playback procedure to replay the memo voice file of the image if it is judged that the memo voice playback function is enabled.

3. The memo voice recording/playback method in accordance with claim 2, wherein if it is judged that the memo voice playback function is not enabled, the method further comprises:
judging whether or not a next image is to be displayed;
displaying the next image if it is judged that a next image is to be displayed; and
displaying an image selection screen if it is judged no next image is to be displayed.

4. The memo voice recording/playback method in accordance with claim 3, wherein the image is an image sequence.

5. The memo voice recording/playback method in accordance with claim 4, wherein after the memo voice recording procedure is completed, the method further comprises:
judging whether or not a current image is one of the image sequence; and
associating the recorded memo voice file with the current image or the image sequence having the current image.

6. The memo voice recording/playback method in accordance with claim 4, wherein when the display unit displays the image selection screen, a plurality of digital photos or a plurality of digital still pictures is selected to constitute the image sequence.

7. The memo voice recording/playback method in accordance with claim 4, wherein the next image is one of another image or another one of the image sequence.

8. The memo voice recording/playback method in accordance with claim 1, wherein if it is judged that the memo voice recording function is not enabled, the method further comprises:
judging whether the memo voice playback function is enabled or not;
judging whether or not the image has a memo voice file associated therewith if it is judged that the memo voice playback function is enabled; and
executing a memo voice playback procedure to replay the memo voice file associated with the image if it is judged that the image has the associated memo voice file.

9. The memo voice recording/playback method in accordance with claim 8, wherein if it is judged that the memo voice playback function is not enabled, a next image is displayed.

10. The memo voice recording/playback method in accordance with claim 8, wherein if it is judged that the image has no memo voice file associated therewith, an alarm message is sent out.

11. The memo voice recording/playback method in accordance with claim 9, wherein if it is judged that the image has the associated memo voice file, the method further comprises:
judging whether or not a music file is being replayed; and
stopping playing the music file if it is judged that the music file is being replayed, and executing the memo voice playback procedure to replay the memo voice file associated with the image.

12. The memo voice recording/playback method in accordance with claim 11, wherein if it is judged that no music file is being replayed, the memo voice playback procedure is directly executed to replay the memo voice file associated with the image.

13. The memo voice recording/playback method in accordance with claim 1, wherein the digital image playback apparatus comprises a digital photo frame.

14. The memo voice recording/playback method in accordance with claim 1, wherein the display unit comprises a display panel.

15. The memo voice recording/playback method in accordance with claim 1, wherein the image is one of a digital photo, a digital still picture, a digital moving image, a message mode screen, and an image sequence.

16. A digital photo frame having memo voice recording function and memo voice playback function, the digital photo frame comprising:
a display panel for image displaying;
a memo voice recording module;
a memo voice playback module;
a control module configured to control the display panel, the memo voice recording module, and the memo voice playback module such that when the display panel displays an image and the memo voice recording function of the digital photo frame is enabled, the control module controls the memo voice recording module to execute a memo voice recording procedure so as to edit the recorded memo voice into a memo voice file associated with the image.

17. The digital photo frame in accordance with claim 16, wherein when the display panel displays the image and the memo voice playback function of the digital photo frame is enabled, the control module controls the memo voice playback module to execute a memo voice playback procedure so as to replay the memo voice file associated with the image.

18. The digital photo frame in accordance with claim 17, wherein before the memo voice file associated with the image is replayed, the control module judges whether or not the image has a memo voice file associated therewith, and if it is judged that the image has an associated memo voice file, the control module controls the memo voice playback module to execute the memo voice playback procedure so as to replay the associated memo voice file.

19. The digital photo frame in accordance with claim 18, wherein if the control module judges that the image has no associated memo voice file, the control module further controls the display panel to display an alarm message.

20. The digital photo frame in accordance with claim 18, wherein if the control module judges that the image has an associated memo voice file, the control module further judges whether or not the memo voice playback module is replaying a music file, and if it is judged that the memo voice playback module is replaying a music file, the control module controls the memo voice playback module to stop replaying the music file and execute the memo voice playback procedure so as to replay the memo voice file associated with the image.

21. The digital photo frame in accordance with claim 16, wherein the memo voice recording module comprises:
a microphone controlled by the control module, configured to receive the memo voice and transmit the received memo voice to the control module for processing; and
a memory module controlled by the control module and configured to store the memo voice file.

22. The digital photo frame in accordance with claim 16, wherein the memo voice playback module comprises a speaker.

23. The digital photo frame in accordance with claim 16, further comprising an operation interface to transmit an operation command from a user to the control module.

24. The digital photo frame in accordance with claim 16, wherein the image is one of a digital photo, a digital still picture, a digital moving image, a message mode screen, and an image sequence.
